(19) United States
(12) Patent Application Publication
(10) Pub. No.: US 2011/0233898 A1
(43) Pub. Date: Sep. 29, 2011

(54) MECHANICAL CONNECTION DEVICE BETWEEN A MOTORIZED VEHICLE AND WORKING EQUIPMENT

(76) Inventors: Dominique Hembise, Plaisir (FR); Francois Sylvain Crosnier, Voisins-Le-Bretonneux (FR); Alain Guesdon, Noisy-Sur-Ecole (FR)

(21) Appl. No.: 13/132,043

(22) PCT Filed: Dec. 8, 2009
(86) PCT No.: PCT/FR09/52438

§ 371 Date: May 31, 2011

(30) Foreign Application Priority Data
Dec. 10, 2008 (FR) 0806922

(51) Int. Cl. B62D 49/04

(52) U.S. Cl. 280/481

(57) ABSTRACT

The present disclosure relates to a mechanical connection device between a motorized vehicle and working equipment. According to the present disclosure, the device includes a rigid plate mounted by means of axles in the tow rings of the vehicle and bearing adjustable skids that are applied against a transverse surface of the vehicle, such as to abutt the connection device to the vehicle, thereby securing the same.

### CROSS-REFERENCE TO RELATED APPLICATION(S)

This is a national phase application under 35 U.S.C. §371 of PCT Application No. PCT/FR2009/052438, filed Dec. 8, 2009, which claims the benefit of French application Ser. No. 08/06922 filed Dec. 10, 2008, the contents of which are expressly incorporated herein by reference.

### FIELD OF ART

The present disclosure relates to a mechanical connection device adapted to be arranged between a motorized vehicle and a working equipment or system mounted on rolling members, as well as a motorized assembly comprising the vehicle and the equipment connected to each other via said connection device.

### BACKGROUND

More particularly, although not exclusively, the mechanical connection device is intended for equipping military vehicles or devices such as those pushing a mine-clearing driving equipment for detecting and detonating improvised explosive devices buried into the ground or laid thereon, but, of course, it could be mounted on any other type of vehicles for other purposes.

As known, known mine-clearing equipment for fighting against improvised explosive devices comprise a supporting structure bearing on which there are mounted, more particularly, at some safety distance from the motorized vehicle, triggering decoys for explosive devices. Such a structure relies on rolling members, such as wheels, and is made integral with the front of the motorized vehicle.

The connection between the supporting structure of the equipment and the front of the vehicle is implemented from a large number of components, such as joints, small rods, supports, etc. to be adapted and mounted directly on the front of the vehicle through numerous and difficult assembling, drilling, welding, etc. operations. Taking into account the various shapes and dimensions of the equipment to be pushed and of the motorized vehicles, each connection is often specific and structurally and functionally different, and requires a particular study for the adaptation of a given pushed equipment to such a motorized vehicle, so multiplying the type of components to be provided, increasing the costs and thus requiring a consistent supply.

### SUMMARY

The present method, system and device aim at solving such drawbacks and relate to a mechanical connection device, the design of which makes it possible to adapt it to most motorized vehicles, including of the military type, and to be able to directly mount on the latter the pushed equipment without implementing long and tiresome operations on the motorized vehicle.

Moreover, as known, most military vehicles are provided, at the front, with towing rings, for usual towing and slinging purposes. Such towing rings provided on such vehicles are dimensioned so as to be submitted to very high stresses, significantly higher than those required for the application of the present method, system and device and have identical general dimensions, even rather close from one vehicle to the other. They are moreover arranged in the lower front part of vehicles generally on a bumper or a weathering being a strong area of the vehicle, this being particularly suited for anchoring the equipment.

Thus, taking all this into account, the mechanical connection device being the object of the present method, system and device and intended for connecting a motorized vehicle provided, on a transverse surface thereof, with two parallel towing rings, the eyelets of which are aligned, to a working equipment with rolling members moved by said vehicle, is remarkable, according to the present method, system and device in that it comprises:

a rigid plate able to receive said equipment and to reach a position substantially between said two towing rings and in two lateral sides of which holes are arranged, being able to come opposite said ring eyelets;

axes being respectively housed in said aligned holes and eyelets so as to carry said plate; and

abutment skids arranged between said transverse surface of the vehicle and said plate, and associated with the latter, movably, by a controllable adjustment means, so as to space apart from said plate and apply against said transverse surface of said vehicle.

Thus, advantageously, the existing towing rings of vehicles are used for simply adapting the mechanical connection device of the present method, system and device then acting as a standard interface between most vehicles and rolling materials.

Furthermore, as the rigid plate is retained through axes inserted in the eyelets of the rings integrally formed with the vehicle, the abutment skids can apply strongly against the transverse surface of the vehicle through the action of said securing means, until the abutment effort of the skids on said surface results in the connection device being unable to move whatever the intensity of the external mechanical actions so as to get a buttressing phenomenon.

It is also noticed, that there is no need to implement assembling, drilling, welding operations or other in the structure of the vehicle for securing the connection device and that the assembling and, accordingly, the dismantling of the latter, and therefore the removability of the device, are particularly easy without affecting the structure of the vehicle, which is particularly valuable. The connection device, if it has not been damaged by an explosive device, could therefore be used again on another vehicle or remain permanently on the latter.

Preferably, each axis is mounted in said respective lateral hole of the rigid plate so as to make up with the latter a linear actuator being controllable for moving said axis between an extended position associating said plate with said towing ring and a retracted position separating said plate from said ring, and reciprocally. Thus, the axes act as locks, allowing, more particularly, the mechanical connection device of said towing rings to be easily assembled and dismantled.

Advantageously, controlling each of the axes occurs from a power source.

In particular, each axis could then be submitted, on the one hand, to the action of an elastic member arranged in said lateral hole of the plate and sliding said axis for the engagement in said corresponding eyelet and, on the other hand, to the action of said power source acting to meet said elastic member so as to retract said axis in its lateral hole. Indeed, as assembling the axes does require any significant effort, a single spring is sufficient for having the axis slide in the corresponding eyelet. On the other hand, dismantling, more particularly when the working equipment has been damaged, resulting in deformations on the connection device, could require a more significant energy for retracting the axes, delivered by the action of the power source.

Advantageously, said power source is of the fluidic type and is defined by an accumulator able to be loaded from a pump or a pressurized fluid circuit of said vehicle.

Said power source could also be of the electrical type.

According to another feature of the mechanical connection device, said means for controlling said abutment skids is of the screwing type and is defined by at least one threaded rod, being integral with each skid and crossing, through its free end, said plate maintained in position by said axes, and by a nut cooperating with the free end of said rod. Thus, abutments of the axes in the eyelets are used for buttressing against the front transverse surface of the vehicle by means of the abutment skids, imparting a particularly strong connection of the device to the vehicle.

For example, each abutment skid could comprise a small plate and a liner arranged on said small plate and cooperating with said transverse surface of the vehicle.

Furthermore, said abutment plate comprises a joint intended for allowing anchoring said working equipment. In a preferred embodiment, said joint comprises at least two bearings being integral with said plate on the side opposite that provided with said abutment skids, and aligned in parallel to the mounting axes of said plate on said rings, said bearings being able to receive axes associating or releasing said working equipment from said plate.

Controlling the axes associating the working equipment with the plate of the connection device could occur advantageously identical to that of said axes associating the vehicle with the plate of such a connection device.

Thus, the working equipment could be separated from the connection device while maintaining the latter associated with the vehicle.

Furthermore, in another embodiment, the device could comprise controllable pyrotechnic loads associated with the axes connecting said plate to the towing rings of the vehicle and to the working equipment. Thus, the action of such loads at the level of the axes results in the device being separated from said working equipment and/or from said vehicle.

The present method, system and device also relate to a motorized assembly of the type comprising an engine vehicle before which a working equipment is mounted with rolling members. Advantageously, the assembly is remarkable in that it comprises a mechanical connection device such as defined herein above.

### BRIEF DESCRIPTION OF THE FIGURES

The FIGS. of the appended drawing will better explain how the present method, system and device can be implemented. In these FIGS., like reference numerals relate to like components.

FIG. 1 is a partial perspective view showing a motorized assembly comprising, for connecting the working equipment to the engine vehicle, a mechanical connection device according to the present method, system and device.

FIG. 2 is a bottom perspective view of said connection device mounted at the front of the vehicle.

FIG. 3 shows, in a longitudinal section, an adjustment means for securing a skid to the vehicle by means of the rigid plate of the connection device.

FIGS. 4A and 4B are longitudinal sections, according to an embodiment, of one of the supporting axes of the plate to the corresponding towing ring, before and after being introduced in the eyelet thereof.

FIG. 5 is a perspective view showing another embodiment of said rigid plate of the connection device.

### DETAILED DESCRIPTION

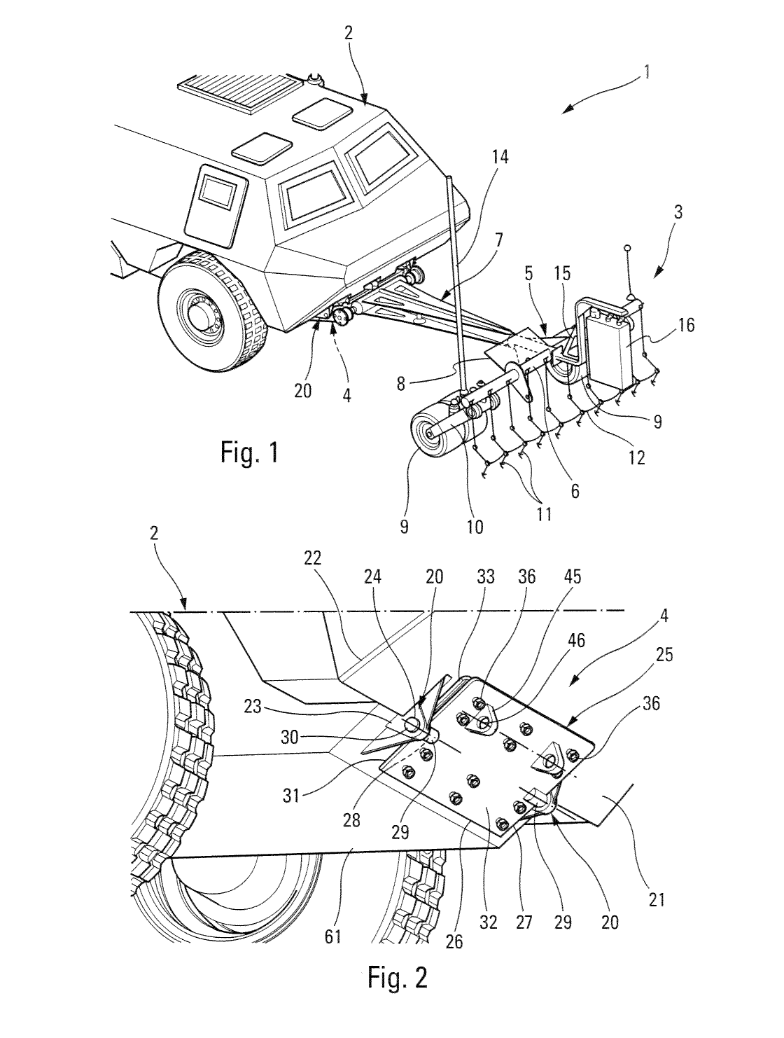

The motorized assembly 1 shown on FIG. 1 comprises, in this example, a military vehicle or device 2 of the armoured type and a rolling working equipment 3 arranged before the military vehicle 2 by means of a mechanical connection device 4 according to the present method, system and device and intended, in this present preferred embodiment, for detecting and triggering not shown improvised explosive devices, partially or completely buried in the ground.

Briefly, the equipment 3, pushed by the vehicle 2, comprises:
a front structure 5 with a transverse beam 6 at least as wide as the vehicle 2;
a rear longitudinal structure 7, hinged on the one side to the connection device 4 and bearing, on the other side, the transverse beam 6 of the front structure, so as to position the latter at an appropriate distance from the vehicle 2 for protection and safety purposes;
rolling members 9, such as aligned twin wheels, carried by means of arms 10 hinged to the beam 6 and having a position stabilisation, mobility and decoying function of mechanical sensors for triggering improvised explosive devices;
claws 11 issued from the beam 6 and catching, via their free ends, wires and filaments lying on the ground;
a transverse sling 12 connecting the claws 11 so as to intercept antennas;
a pole 14 intercepting air wires and fastened to the beam;
a platen 15 mounted on the beam and bearing for example an infrared decoy 16; and
an interface member 8 arranged on the front structure 5 for carrying a not shown detecting, decoying or jamming system.

Of course, the pushed equipment 3 for detecting and triggering improvised explosive devices could have a different structure and be provided with other equipment.

As shown on FIG. 2, the connection device 4 of the present method, system and device could be advantageously mounted between the two identical towing rings 20 usually arranged at the front of military motorized vehicles and previously described. In particular, such rings 20 are issued from the tilted transverse surface 21 of the weathering or bumpers 22 (for some vehicles) of the vehicle 2 and are each defined by a body or fitting 23 being integral with and perpendicularly projecting with respect to the front transverse surface 21, and provided with a circular eyelet 24 for anchoring a towing device. The eyelets 24 of those rings 20 are perpendicularly aligned to the vertical longitudinal plane of the vehicle, i.e parallel to the transverse surface 21.

Thus, the connection device 4 comprises a rigid plate 25 having a substantially rectangular shape in this embodiment, the length of the large sides 26 of which corresponds to the spacing between the two rings 20 so as to be able to be mounted therebetween. To this end, the plate 25 has on its two lateral sides or small sides 27, substantially in the centre thereof, holes 28 (FIGS. 2, 4A, 4B and 5) arranged in respective cylindrical bosses 29 of said sides 27, the diameter of which could correspond to that of the eyelets. And axes 30 are respectively inserted in the aligned eyelet 24—hole 28 assemblies for supporting the rigid plate 25 with respect to the rings 20. Thus, the rigid plate has one 31 of its main sides facing the tilted transverse surface 21 of the vehicle 2 and the other side 32 facing outwards and receiving, as will be set forth later, the longitudinal structure 7 of the working equipment to be pushed 3.

The connection device 4 further comprises abutment skids 33 (FIGS. 2, 3 and 5) being movably connected with respect to the rigid plate 25 and to be used for applying against the tilted transverse surface 21 of the front of the vehicle 2. They are thus arranged between such a transverse surface 21 and the inner side 31 of the plate 25, facing the vehicle, and parallel to such a side.

In this embodiment, the skids 33 are identical, have a rectangular shape and are three in number while being arranged vertically in the higher part of said rigid plate 25 with respect to the assembly axes 30 thereof in the rings, the one in the middle and the two others near lateral sides 27.

Each abutment skid 33 comprises a small rigid plate 34 on which there is secured, by any appropriate means, a liner 35 made in an appropriate material, coming in contact with the front transverse surface 21 of the vehicle.

In order to prevent the small rigid plate from oscillating with respect to the rings and to firmly apply the mechanical connection device against the front of the vehicle via its skids, the device 4 comprises a controlling means 36 associating each skid 33 with the plate 25, and more particularly in the illustrated example, two identical controlling means for each skid.

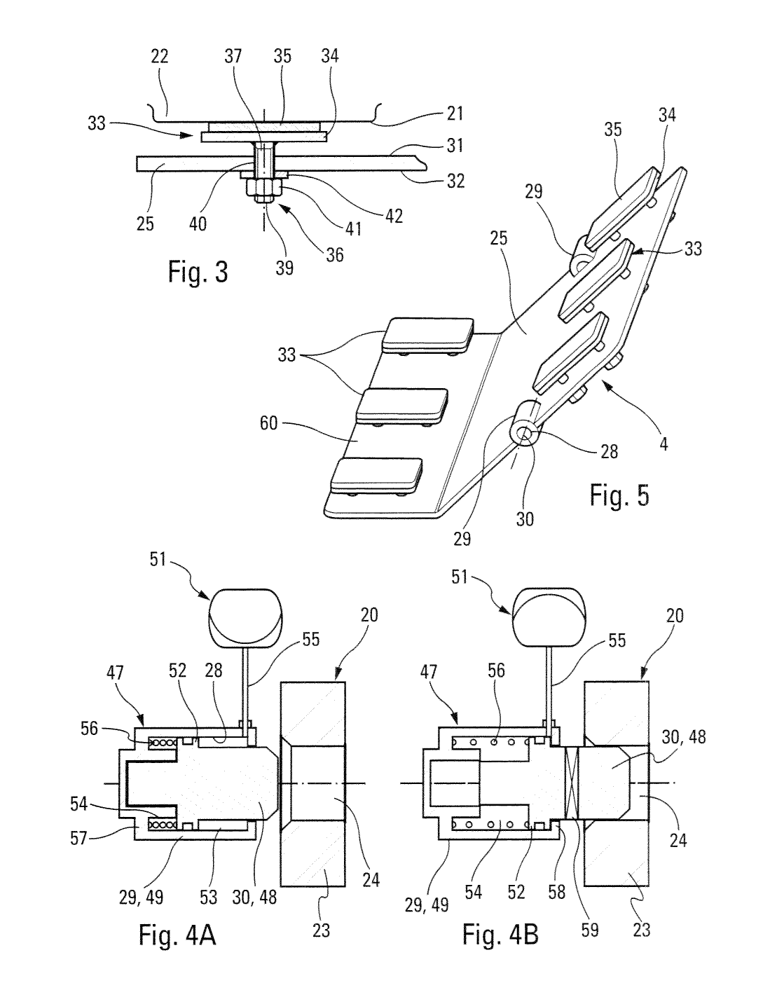

In the embodiment shown on FIGS. 2 and 3, the controlling means 36 comprises a threaded rod 37 being integral perpendicularly, through welding or other, with the external side 32 of the small plate of each skid and crossing, via its free end 39, a passage 40 arranged in the rigid plate 25, and a clamping nut 41 mounted on the threaded end 39 of the rod.

Mounting the mechanical connection device 4 at the front of the vehicle 2 does not involve any difficulties. The skids 33 are first associated with the rigid plate 25 while introducing the threaded rods 37 of each of them in the respective passages 40 of the plate, then mounting the nuts 41 with their washers 42 on the free ends 39 of the rods. The skids 39 are afterwards adjusted to the closest to the side 31 of the plate. The latter is presented between the two rings 20 so as to have the eyelets 24 coincide with the lateral blind holes 28 of the plate. The axes 30 are engaged into the respective holes 28 and eyelets 24 with a preferably gliding adjustment. Then, the skids are brought, via their liners 35, against the front transverse surface 21 of the vehicle 2 and, as the plate 25 is maintained fixedly in position by the axes 30, the action of the nuts 41 on the threaded rods tends to space apart the plate of the transverse surface 21 being thereby in constraint against the axes 30 with an higher effort than the running efforts necessary to moving the motorized assembly 1.

Thus, the eyelets of the rings, via the axes, act as an abutment for the plate so as to drive the buttressing of the skids against the front transverse surface of the vehicle, thus imparting to the mechanical connection device 4 a total and reliable securing position, without either impairing or modifying the structure of vehicle 2. Thus, it can be particularly easily and rapidly mounted, and dismantled.

Furthermore, it can be seen on FIG. 2, that the rigid plate 25 comprises, on the external side thereof 32, two identical jointing bearings 45 for mounting the working equipment 3 and arranged according to an axis perpendicular to the vertical longitudinal symmetry plane of the vehicle. Those two bearings 45 are located in the upper part of the plate 25, near its lateral sides, and are provided with aligned passing holes 46 parallel to the mounting axes 30 of the plate on the rings. Thus, in these passing holes 46, not shown jointing axes are mounted for associating, appropriately, as shown on FIG. 1, the rear of the longitudinal structure 7 of the working equipment 3 at the front of the engine vehicle 2 via the mechanical connection device 4 acting as an interface.

In another embodiment, sliding the jointing axes 30 of the rings 20 to the rigid plate 25 could be controlled, similarly to an electric or fluidic (hydraulic or pneumatic) type jack actuator 47. In this case, each axis 30 corresponds to a piston rod 48 of the actuator 47, the body or cylinder 49 could be the boss 29 of the plate or could be arranged fixedly on the latter, replacing the boss. And the hole 28 is replaced by the two chambers 53, 54 bounded by the piston rod 48 in the body 49 of the actuator 47.

Thus, it can be seen on FIG. 4A, one of said axes 30 forming the rod 48 of the actuator 47 and occupying a retracted position in the body 49 of the actuator, said axis 30 facing the eyelet 24 of the corresponding towing ring 20.

In this example, each axis 30 occupies a retracted position under the fluidic action of a power source such as a membrane accumulator 51 loaded, at the start of the mission, with the motorized assembly 1, for example, from a not shown simple lever pump. The accumulator could also be loaded 51 from the pressure build-up of the hydraulic or pneumatic circuit of the vehicle 2 by a flexible connection, but the autonomous character of the accumulators is preferred in order to avoid tapping power from the vehicle.

In order to reach the retracted position, said axis 30 or rod 48 has an external annular shoulder 52 separating the body tightly into the first 53 and second 54 chambers and submitted, on the side of the first chamber 53, to the pressurized fluid issued from the accumulator 51 by a flexible connection 55 and, on the side of the second chamber 54, to a elastic member such as a compression spring 56 arranged between the bottom 57 of the body 49 of the actuator 47 and the annular shoulder 52. Thus, when the fluid pressure in the first chamber 53 applies on the external annular shoulder 52, it overcomes the action of the spring 56 which becomes compressed under the sliding axis 30 then occupying the retracted position illustrated on FIG. 4A.

On the other hand, when the mechanical connection device 4 is to be assembled to the weathering or the bumper 22 of the vehicle, upon a mission, and the axes 30 are opposite the respective eyelets 24, the accumulators 51 are isolated from the chamber 52 being then brought to the atmospheric pressure (for example, by means of a not shown three way valve), dropping the pressure in the first chambers 53. Thereby, under the action of compression springs 56 that could have a low power, the axes 30 switch from the retracted position. FIG. 4A, to the extended position. FIG. 4B, slidably engaging, as a lock, in the eyelets 24 of the towing rings 20.

The external annular shoulder 52 of each axis comes then in abutment against a front internal annular shoulder 58 of the body.

Thus, using accumulators 51 is particularly advantageous when it is desired “to release” or to break away from the motorized vehicle 2, the working equipment 3, as well as the associated connection device 4, as a result of an improvised device explosion, leading to it being damaged, as said accumulators 51 are able to restore a high fluid energy for retracting the axes 30 and thereby overcome the buttressing and jamming that could be caused by the pushed equipment being damaged. Releasing occurs, for example, by inverting the position of the three way valve.

In another not shown embodiment, releasing the axes 30 could be achieved by pyrotechnic loads surrounding, for example, the axes or inserted therein, and able to be fired from the interior of the motorized vehicle.

Instead of acting on the axes 30 associating the connection device 4 with the towing rings 20 for releasing the working equipment 4, the jointing axes provided between the longitudinal structure 7 of the working equipment and the bearings 45 of the rigid plate of said device could obviously be used, and could be there too assimilated to actuator rods.

On these axes, there could also be arranged pyrotechnic loads 59 shown on FIG. 4B and known as such (fuse or other) for leading the working equipment 3 to separate from the mechanical connection device 4.

In the embodiment of FIG. 5, the rigid plate 25 comprises an extension part 60, bendingly extending the initial plate for being able to apply, via the skids 33 as well, against the bottom 61 of the structure of the motorized vehicle 2, extending the front tilted transverse surface 21 of the weathering.

1. A mechanical connection device intended for connecting a motorized vehicle provided, on a transverse surface thereof, with two parallel towing rings having their eyelets aligned, to a working equipment with rolling members moved by said vehicle,
said mechanical correction device comprising:
a rigid plate able to receive said equipment and to reach a position substantially between said two towing rings and in two lateral sides of which holes are arranged, being able to come opposite said ring eyelets;
axes being respectively housed in said aligned holes and eyelets so as to carry said plate; and
abutment skids arranged between said transverse surface of the vehicle and said plate, and associated with the latter, movably, by a controllable adjustment means, so as to space apart from said plate and apply against said transverse surface of said vehicle.

2. The device according to claim 1,
wherein each axis is mounted in said respective lateral hole of the rigid plate so as to make up with the latter a controllable linear actuator for moving said axis between an extended position associating said plate with said towing ring and a retracted position separating said plate from said ring, and reciprocally.

3. The device according to claim 2,
wherein the control of each of the axes is issued from a power source.

4. The device according to claim 3,
wherein each axis is submitted, on the one side, to the action of an elastic member provided in said lateral hole of the plate and sliding said axis for the engagement in said corresponding eyelet and, on the other side, to the action of said power source acting to meet said elastic member for retracting said axis in its lateral hole.

5. The device according to claim 3,
wherein said power source is of the fluidic type and is defined by an accumulator able to be loaded from a pump or a pressurized fluid circuit of said vehicle.

6. The device according to claim 3,
wherein said power source is of the electric type.

7. The device according to claim 1, wherein said control means for said abutment skids is of the screwing type and is defined by at least one threaded rod being integral with each skid and crossing, through the free end thereof, said plate maintained in position by said axes, and by a nut cooperating with the free end of said rod.

8. The device according to claim 1, wherein each abutment skid comprises a small plate and a liner arranged on said small plate and cooperating with said transverse surface of the vehicle.

9. The device according to claim 1, wherein said abutment plate comprises a joint intended for allowing said working equipment to be anchored.

10. The device according to claim 1,
wherein said joint comprises at least two bearings being integral with said plate on the side opposite that provided with said abutment skids, and aligned in parallel to the mounting axes of said plate on said rings, said bearings being able to receive axes associating or releasing said working equipment from said plate.

11. The device according to claim 1,
further comprising controllable pyrotechnic loads associated with the axes connecting said plate to the towing rings of the vehicle and to the working equipment.

12. A motorized assembly of the type comprising an engine vehicle in front of which a working equipment with rolling members is mounted,
comprising a mechanical connection device such as defined in claim 1.
